(19) United States
(12) Patent Application Publication
(10) Pub. No.: US 2018/0301031 A1
(43) Pub. Date: Oct. 18, 2018

(54) A METHOD AND SYSTEM FOR AUTOMATICALLY DETECTING AND MAPPING POINTS-OF-INTEREST AND REAL-TIME NAVIGATION USING THE SAME

(71) Applicant: PARKAM (ISRAEL) LTD., Modi'in (IL)

(72) Inventors: Asaf Naamani, Ofakim (IL); Ori Attar, Modi'in (IL)

(21) Appl. No.: 15/569,356

(22) PCT Filed: Apr. 25, 2016
(86) PCT No.: PCT/IL2016/050434

§ 371 Date: Oct. 25, 2017

(30) Foreign Application Priority Data
Apr. 26, 2015 (IL) 238473

(51) Int. Cl. G08G 1/14; G06K 9/00; G06T 7/80; G06K 9/46; G06T 7/60; G01C 21/36; G05D 1/02

(52) U.S. Cl. CPC G08G 1/148; G05D 2201/0213; G06T 7/80; G06K 9/4604; G06K 9/00812; G06K 9/00778; G06T 7/60; G01C 21/3685; G01C 21/3682; G05D 1/0212; G08G 1/141; G08G 1/144; G06T 2207/30264; G06T 2207/20081; G06T 2207/20076; G06K 2209/23; G06K 2209/15; G06K 9/00798

(57) ABSTRACT

The present invention relates to a system and method for automatically detecting and mapping points-of-interest (POI) such as parking spaces, and accordingly locating and directing drivers to available parking spaces as close as possible to desired POI and locations. The system is completely autonomous and independent and it uses a Parking Space Detection module that employs machine learning and computer vision techniques for learning the surface of the parking area, the unoccupied life span of a parking space, the occupancy life span of the parking space, detection of suspicious vehicles in terms of parking searcher to independently predict in which available parking space they may parked, and accordingly to navigate in real-time a user to a parking space that has the highest probability to remain free on arrival of that user.

### FIELD OF THE INVENTION

The present invention relates to the field of parking systems. More particularly, the invention relates to a method and system of real-time detecting and mapping of points-of-interest (POI) such as parking spaces and nearby shops based on data captured by visual means such as cameras, and implementing such detections with real-time navigation services, in particular providing innovative navigation capabilities within a parking lot or other parking facilities. Moreover, the present invention provides an intelligent computer vision solution that enables to navigate a user in real-time to a parking space that has the highest probability to remain free on arrival and that is close as possible to a desired POI, by independently and autonomously learning the availability life span of the parking spaces.

### BACKGROUND OF THE INVENTION

In the prior-art, there is no real solution to the problem of automatically mapping points-of-interest such as parking space, shops located at a given shopping area, an entrance to a parking lot, etc., at almost any given location (e.g., navigation capabilities within a parking lot). For example, U.S. Pat. No. 6,970,101 discloses a method of matching a vehicle with a vacant parking space in a parking facility having numerous parking spaces. The method includes storing identifying characteristics of each of the parking spaces in a database. To request a parking space, a garage customer inputs data concerning his or her preferences for parking. This method determines which of the plurality of parking spaces are vacant, matches the data inputted by the user with the data identifying characteristics of each of the parking spaces determined to be vacant, and determines which of the parking spaces determined to be vacant most closely matches the data inputted by the user. The closest parking space is reserved for parking by the user. However, such method is limited to known parking spaces at a given garage and it lacks the ability to assign real-world coordinates to such parking spaces. Moreover, such method lacks the ability to autonomously detect and map parking spaces or POI, neither in real-time or off-line. Moreover, such solutions lack the ability to provide real-time navigation to a parking space that has the highest probability to remain free on arrival of the user, not to mention taking into consideration that the parking space should be as close as possible to a desired POI.

It is an object of the present invention to provide a system which is capable of automatically mapping parking spaces or other POI at any given location and assigning a real-world coordinates to each located parking space or POI.

It is another object of the present invention to provide a system that enables to navigate a user, in real-time, to a parking space that has the highest probability to remain free on arrival and that is close as possible to a desired POI.

It is yet another object of the present invention to provide a system which is capable of independently and autonomously learning the availability life span of a parking space with respect to deferent timing during a given period, such during holidays, winter, summer, days of the week, etc.

It is another object of the present invention to provide a system which is capable of automatically detecting available parking spaces and directing a driver to the exact location of a detected and currently available parking space.

It is yet another object of the present invention to provide a system which is capable of automatically defining the location and size of a parking space, thereby enabling to match the size of vehicle to a corresponding available parking space.

It is a further object of the present invention to provide a system which is capable of enabling a self-driving car to automatically navigate to the exact location of a detected available parking space and to automatically park there.

It is a further object of the present invention to provide a system which is capable of reporting a user the location of the parking space in which his/her self-driving is parking.

It is yet another object of the present invention to provide a system which is capable of enabling a self-driving car to automatically navigate from the parking space to the exact location of a user, thereby providing an automatic “pick-up” service.

It is still another object of the present invention to provide a system which is capable of automatically associating each parking space with commercial content that is related to nearby POI.

Other objects and advantages of the invention will become apparent as the description proceeds.

### SUMMARY OF THE INVENTION

The present invention relates to a method for detecting and mapping parking spaces, comprising the steps of:
a) extracting parking space regions from images captured with one or more cameras by applying image processing algorithm on the captured images for automatically defining areas in said images as parking spaces, wherein said image processing algorithm involves unsupervised camera calibration based on road surface marking and size estimation of a standard parking space for providing independent geometrical calibration of said one or more cameras without any human intervention; and
b) Mapping the extracted parking space regions by assigning to each individual parking space real-world coordinates, by using a coordinate algorithm that projects and transforms image processing coordinates into real-world coordinates.

According to an embodiment of the invention, the method further comprises automatically distinguishing between currently available and unavailable parking spaces among the extracted parking spaces, thereby enabling to detect the availability of each parking space in real-time.

According to an embodiment of the invention, further comprising independently and autonomously learning life span availability of a parking space, thereby enabling to navigate a user in real-time to a parking space that has the highest probability to remain free on arrival as well as enhancing the estimated arrival time for an available parking space. In addition, enabling navigating the user in real-time to an available parking space that is close as possible to a desired POI, thereby also eliminating the need to search for an available parking space within a parking lot or other parking area with respect to a desired POI.

According to an embodiment of the invention, the method further comprises applying an optimization process for distinguish in real-time between available and unavailable parking space by utilizing parameters of parking locations and vehicles.

According to an embodiment of the invention, the method further comprises detecting crowded areas by using computer vision for understanding the captured images by analyzing data from the real world in order to produce real-time information that represents the level of crowdedness as appear in said captured images, and accordingly to provide data suitable to navigate a user, in real-time, away from those crowded areas to a parking space via a less crowded travelling route, in order to decrease the time it takes for the user to arrive at a destination parking space or to avoid undesired crowded areas.

According to an embodiment of the invention, the method further comprises providing an independent navigation system for detecting a vacant parking space in an underground/indoor parking lot and accordingly providing navigation data to said vacant parking space, by using processing of visual data provided by images captured with a plurality of cameras deployed in said parking lot, thereby eliminating the need to use traditional GPS-based navigation. According to an embodiment of the invention, the processing of visual data includes optical flow techniques to provide navigation data to the vacant parking space in the underground/indoor parking lot. The optical flow technique may utilize pattern of apparent motion of vehicles in a visual scene caused by the relative motion between a camera and the scene. According to another embodiment, the processing of visual data includes detecting and tracking the license plate of each vehicle that drives through said underground/indoor parking lot.

According to an embodiment of the invention, the method further comprises detecting Point-of-Interest (POI) located near the mapped parking spaces, and assigning real-world coordinates to said POI for mapping said POI, thereby enabling a navigation service to navigate a user directly to an available parking space that is located as close as currently possible to a desired POI. For example, the POI can be a specific location that someone may find useful or interesting, including a place of business or service such as point-of-sale, stores, shops, service providers, restaurants, theaters, hotels, campsites, and the like.

According to an embodiment of the invention, the mapped parking spaces and the mapped POI are added to an existing navigation application/service as an additional data layer.

According to an embodiment of the invention, the method further comprises defining the size of each parking space, thereby enabling to match the size of a specific vehicle with an available parking space having corresponding sizing.

According to an embodiment of the present invention, the method further comprises enabling a self-driving vehicle to automatically navigate, in real-time, to the location of a currently available parking space, in order to park in said parking space, by providing data representing the real world coordinates of mapped parking space. According to an embodiment of the invention, the location of the currently available parking space is as close as possible to a location where the self-driving vehicle drops-off a specific passenger.

According to an embodiment of the present invention, the method further comprises enabling the self-driving vehicle to report the location in which said self-driving is actually parking.

According to an embodiment of the present invention, the method further comprises enabling a self-driving vehicle to automatically exit from the parking space and to navigate to another location according to instruction provided by a user or a service.

According to an embodiment of the present invention, the another location is the exact location of a user, thereby providing an automatic “pick-up” service.

According to an embodiment of the invention, the method further comprises applying computer vision technique for enabling to learn the properties of each parking space, thereby enabling to navigate a user in real-time to a parking space that has the highest probability to remain free on arrival

In another aspect the present invention relates to a system for detecting and mapping parking spaces, comprising:
a) at least one processor; and
b) a memory comprising computer-readable instructions which when executed by the at least one processor causes the processor to execute a service for detecting and mapping parking spaces, wherein the service:
   i. extracts parking space regions from images captured by one or more cameras by applying image processing algorithm(s) for automatically defining areas in said images as parking spaces;
   ii. maps the extracted parking spaces by assigning to each individual parking space real-world coordinates, by using a coordinate algorithm that projects and transforms image processing coordinates into real world coordinates; and
   iii. stores said mapped parking spaces in a database.

According to an embodiment of the present invention, the method further comprises a parking space occupancy model for automatically distinguishing between currently available and unavailable parking spaces among the extracted parking spaces, thereby detecting available parking space in real-time.

In another aspect the present invention relates to a non-transitory computer-readable medium comprising instructions which when executed by at least one processor causes the processor to perform the method of the present invention.

### BRIEF DESCRIPTION OF THE DRAWINGS

In the drawings:

FIG. 1 schematically illustrates a system for detecting and providing direction to an available parking space, according to an embodiment of the invention;

FIG. 2 schematically illustrates possible components of a detection and mapping server of the system shown in FIG. 1, according to an embodiment of the present invention;

FIG. 3 schematically illustrates in a flowchart form a method for detecting and providing direction to an available parking space, according to an embodiment of the invention;

FIG. 4 schematically illustrates a heatmap flow generation of a parking lot, according to an embodiment of the invention;

FIG. 5 is a screenshot that schematically illustrates an example of a partial navigation route to an available parking space near a desired POI in a parking lot of a specific shopping center; and

FIG. 6 schematically illustrates a method of generating a single vectorial route to a destination, according to an embodiment of the invention.

### DETAILED DESCRIPTION OF THE INVENTION

Reference will now be made to several embodiments of the present invention, examples of which are illustrated in the accompanying figures. Wherever practicable similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

The present invention provides a system that automatically detects and maps points-of-interest (POI) such as parking spaces, and accordingly locates and directs drivers to available parking spaces as close as possible to desired POI and locations, including specific shop at a shopping center, airports, stadiums, hotels, parking lots, underground parking garages, inner-city parking lots and city streets. The system is completely autonomous and independent and it uses a Parking Space Detection (PSD) module that employs machine learning and computer vision techniques for learning the surface of the parking area, the unoccupied life span of a parking space, the occupancy life span of the parking space, detection of suspicious vehicles in terms of parking searcher (in particular vehicles that do not use the service provided by the system of the present invention) to independently predict in which available parking space they may parked, and accordingly to navigate in real-time a user (that uses the service provided by the system of the present invention) to a parking space that has the highest probability to remain free on arrival of that user.

It is important to mention that the system of the present invention makes it possible to navigate to an available parking space, regardless whether there are currently other users of the system or no users at all, as the system relies on information received from available cameras and therefore works completely independent.

According to some embodiments, the learning system of the present invention is also based on cross-referencing of previous parking space behavior/events (i.e., occupied and non-occupied durations) in conjunction with special events like holidays (the load holidays in various locations), weekends, weather conditions (that may affect the amount of drivers and activity in various areas), natural disasters, etc., in order to ensure that the system takes into account as much parameters as possible that can affect the probability of the arrival of the driver to an actual available parking space.

The system receives visual information from one or more cameras, such that the field-of-view of each camera is capable of providing at least a partial view of one or more suitable parking spaces in order to be detected and mapped by the system (e.g., the camera can be located in public locations, parking lots or adjacent to them, etc.). The system may further utilize pre-existing cameras or dedicated cameras installed where necessary that may provide visual information regarding the traffic, in order to facilitate the navigation route calculations and timing to arrive at a specific parking destination (e.g., this enables to avoid crowded areas while providing navigation instructions to the parking destination).

The following discussions are intended to provide a brief, general description of a suitable computing environment in which the invention may be implemented. While the invention will be described in the general context of program modules that execute in conjunction with an application program that runs on an operating system on a server and with a mobile app that runs on a mobile device, those skilled in the art will recognize that the invention may also be implemented in combination with other program modules and systems. For example, the method of the present invention can be implemented in existing applications using Application Programming Interface (API).

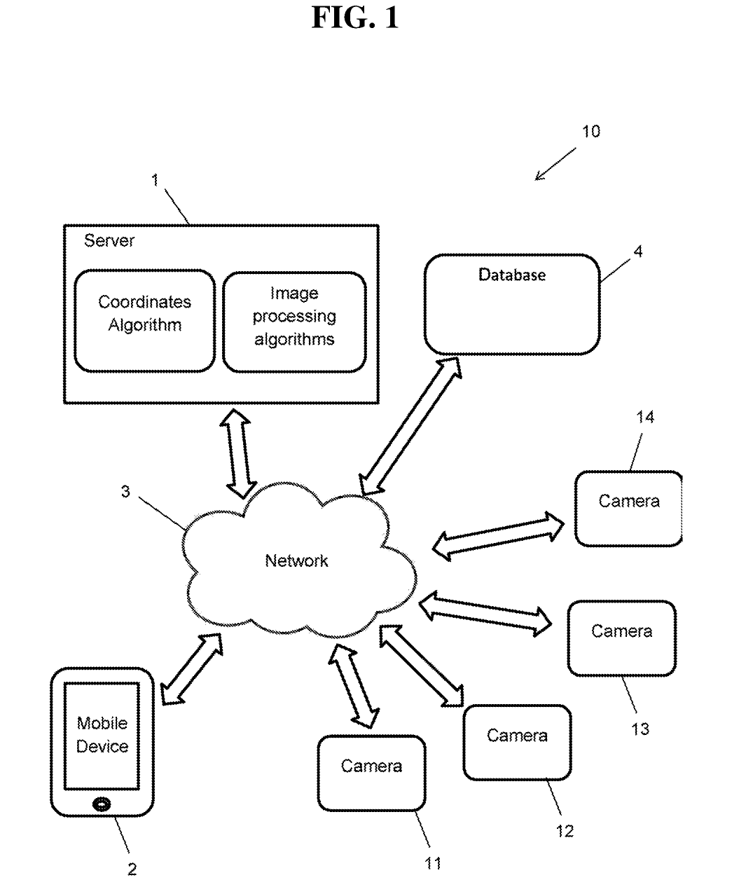

FIG. 1 schematically illustrates a system of detecting and mapping POI based on data captured by cameras, according to an embodiment of the invention. System 10 comprises a detection and mapping server 1 (which can be one or more computers, databases, computers network, cloud etc.) and plurality of cameras deployed in different areas (as indicated by numerals 11-14), wherein the cameras are adapted to communicate with server 1 via a network 3 (e.g., the Internet). In this embodiment, server 1 may store and retrieve information from a database 4.

Each camera 11-14 may capture data representing at least a partial view of one or more POI such as parking spaces. An intelligent and unique Parking Space Detection (PSD) algorithm is applied to the captured data, and through image processing, may extract parking spaces regions by automatically defining areas in the captured data as parking spaces. The PSD algorithm may involve geometric method for providing independent geometrical calibration of the cameras without any human intervention, such as unsupervised camera calibration based on road surface marking and size estimation of a standard parking space. A PSD module that includes the PSD algorithm as well as the machine learning and computer vision will be described in further details hereinafter.

Automatically extracting parking spaces from images (i.e., captured data by cameras) is challenging because their shapes and sizes can be differ from one parking space to another. Thus, the region of each individual parking space needs to be analyzed separately by the PSD module. In addition, the view of the parking spaces as captured by the images might be limited due to environmental factors such as vehicle occupancy, occlusions by structures such as trees and adjacent buildings, or differing illumination conditions (e.g., under the shade of buildings, shadows that changes during daytime, and the like).

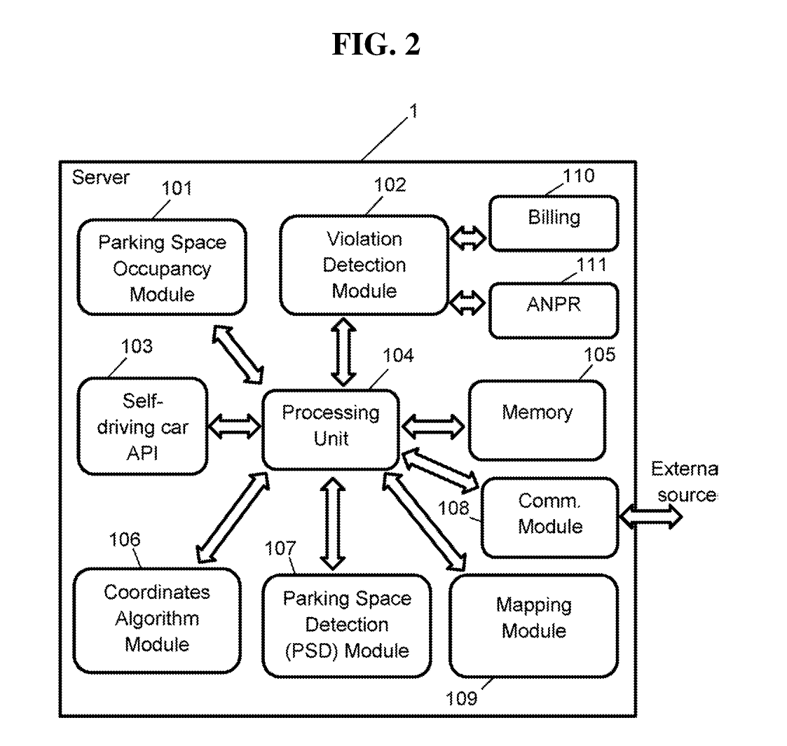

FIG. 2 schematically illustrates the detection and mapping server 1 of system 10, according to an embodiment of the present invention. Server 1 comprises a processing unit 104, a memory 105, a Parking Space Occupancy Module 101, a coordinates module 106, a PSD module 107 and a communication module 108 for communication with external sources such as with database 4 (shown in FIG. 1). Server 1 may further include one or more of the following modules: Violation Detection Module 102 (and its related components a billing component 110 and an Automatic number plate recognition (ANPR) 111), a Self-driving car API 103, and a mapping module 109.

According to an embodiment of the invention, in order to handle these problems effectively and to extract possible parking spaces from the captured images, the PSD algorithm may involve the use of machine learning approaches trained on examples of parking spaces geometries extracted from image of interest. For example, the system may use the examples of common parking spaces geometries as training data for a machine learning module such as Support Vector Machine (SVM) for instance, or other supervised learning models with associated learning algorithms, that may analyze data and recognize patterns, used for classification and regression analysis, to automatically defining areas in the captured images as parking spaces. In some embodiments, the system may utilize the visual data provided by the cameras (i.e., computer vision) to learn the behavior of each individual parking space in order to understand its availability state, such as lighting conditions during different times of the day (e.g., lights and shadows patterns as appear in the images with respect to the parking space in different times when the parking space is either occupied by a vehicle or unoccupied, e.g., during different times of the day, at night, under different weather conditions and at different seasons during the year, etc.), occupancy life span including occupation times, average unoccupied duration, etc. The system uses detection of objects that may exist and influence the appearance of the parking space in the image (e.g., building and trees shadows that cover an unoccupied parking space at specific time in one form and they cover the parking space in other form when the parking space is occupied). This is an example for environment study by the system of a parking space. The system may learn the life span of a parking space by region in each given moment (hourly, daily, weekly and yearly). The system may learn the behavior of vehicles that may indicate that their drivers (which may not necessarily use or connected to the service provided by the system of the present invention) search for a parking space in real-time (e.g., driving slowly near a parking region) and accordingly the system will not navigate a user of the system to the same area of the drivers that already there and looks for an available parking space. Thus, using computer vision techniques to understand images and visual data from the real world enables to produce information to the system of the present invention to navigate a user in real-time to a parking space that has the highest probability to remain free on arrival and that will be close as possible to a desired POI. Moreover, this further enables to facilitate the distribution of the users between the available parking spaces.

According to another embodiment of the present invention, the PSD module may involve any other image feature extractor to detect and describe local features in images in order to extract shapes of parking spaces, like edge detector, texture descriptor, Speeded Up Robust Features (SURF) or other scale and rotation-invariant interest point detector/descriptor, Scale-Invariant Feature Transform (SIFT) algorithm, etc.). The PSD module may parameterize each individual parking space by its width and orientation in image coordinates. For example, the PSD module may extract and compile geometrical meta-information for possible parking spaces, such as lane marking or painted curbstone that may represent a parking space and the like. According to another embodiment, the PSD module may use additional techniques to ensure the currently availability state of a parking space, such as a mask in form of a vehicle that the PSD module matches with each parking space (where matching means that the parking space is occupied), analysis frequency spatial, etc.

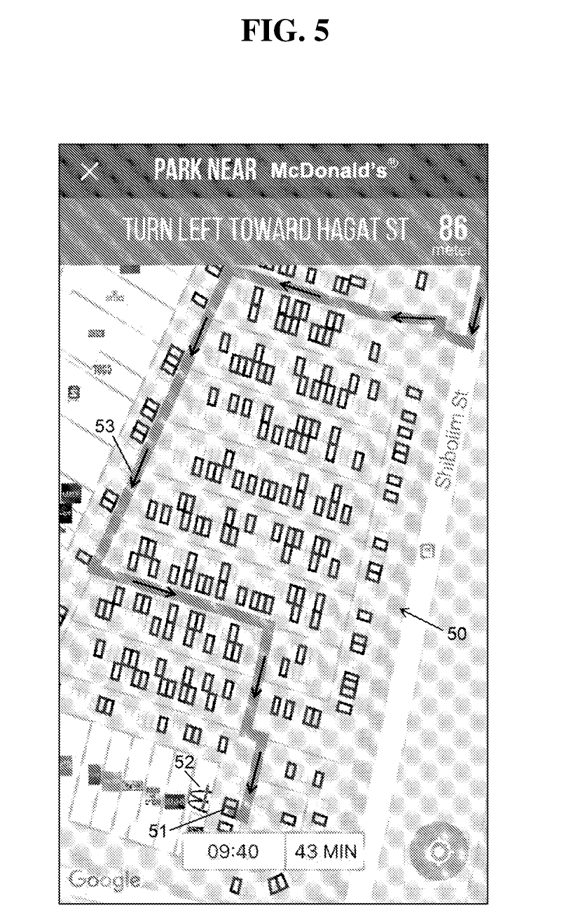

For each defined parking space, system 10 assigns real-world coordinates, as will be described in further details hereinafter, and thereby enabling to map and integrate each individual parking space with navigation services. Upon defining the parking spaces, system 10 may determine the currently availability status of each parking space (i.e., whether it is available or unavailable), thereby enabling to locate available parking spaces in different parking locations, either in parking lots or at any other possible locations. Using its image processing capabilities, system 10 may record and statistically learn the occupation state of each individual parking space, such that system 10 may also predict the availability of each specific parking space during different times of the day. In a navigation mode, system 10 may direct the user to the nearest available parking space to their requested destination, e.g., by providing navigation data via a smartphone equipped with a corresponding mobile navigation app. Using the system 10, users can be very specific about their requested destination, such as a specific POI, and the system will provide direction to the nearest valuable parking space with respect to the desired POI. For instance, the system can guide a user to the nearest parking space to their desired POI, such as a terminal at the airport, or to the parking space that is as close as possible to a specific store at a large shopping mall as shown with respect to FIG. 5, etc. For example, the navigation service can be applied by using a dedicated mobile app or by using third party navigation application such as Waze®, Google maps and the like, on which the system's data of the present invention may appear as an additional/external layer.

According to an embodiment of the present invention, data provided by system 10 may appear as an additional layer on existing navigation mobile app or it may even extend the capabilities of such existing mobile app by providing navigation capabilities to individual parking spaces within a parking lot, e.g., as indicated by the screenshot of FIG. 5 that schematically illustrates an example of a partial navigation route 53 to an available parking space 51 near a desired POI 52 (e.g., McDonald's® restaurant) in a parking lot 50 of a specific shopping center. In this figure, each bolded rectangular represent an available parking space in parking lot 50. The map of the parking spaces in parking lot 50 can be provided as an additional layer in an existing map application (e.g., an additional layer on top of Google® maps) or other forms such as visual information on external street displays/terminals located at the parking lot area, or directional visual marks located within the parking lot (e.g., directional signs or arrows that are formed by an array of LEDs embedded in the surface of the parking area).

Process of Locating Available Parking Spaces

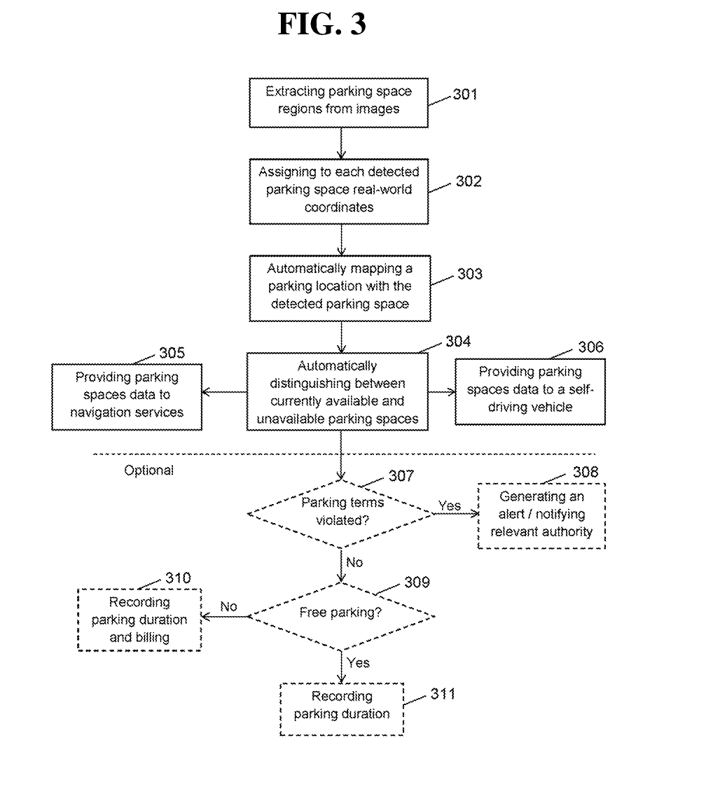

Referring now to FIG. 3, according to an embodiment of the present invention, the process of locating available parking spaces may involve the following steps, while utilizing the aforementioned computer vision and learning techniques:
Detecting parking spaces by extracting parking space regions from images received from one or more cameras (block 301);
Assigning to each detected parking space real-world coordinates (block 302);
Automatically mapping a parking location (e.g., a parking lot) with the detected parking spaces (block 303);
Automatically distinguishing between currently available and unavailable parking spaces (block 304); and
Providing parking spaces data (e.g., coordinates, availability, size, etc.) to navigation services or street displays/terminals (block 305) or to a self-driving vehicle (block 306).

Detailed description of the above process and further possible features will be described herein below.

Mapping the Parking Locations

Upon receiving visual data (i.e., from captured images) from one or more cameras, the PSD module 107 automatically detects and extracts possible parking space regions that may appear in images (block 301). PSD module 107 may also take into account demands and restrictions (e.g., handicaps reserved parking spaces, size of the parking space, non-payment or payment parking areas, etc.) of each individual detected parking space. The PSD module 107 outputs all the parking spaces that are defined as allowed parking spaces, e.g., the output can be presented in a map form (e.g., as shown in FIG. 5). Areas that are not defined as allowed parking spaces will be discarded, and may not be visually appear in the map form. Only allowed parking spaces will be shown in the map. The map may also include other detected POI such as the entrance location to a parking lot, entrance/exit gates, shops, or other special points or items of interest that may appear adjacent to the parking space. According to an embodiment of the invention, system 10 may further identify roadside texture (e.g., using color detection algorithm to identify the color of painted curbstones, where red color may indicate a non-allowed parking region and blue may indicated an allowed parking region).

Locating Available & Unavailable Parking Spaces

After mapping a region with possible parking spaces (e.g., within a parking lot), system 10 searches the map for available parking spaces. Using an image processing algorithm (e.g., that can be suitable for self-supervised learning framework), the system may distinguish between the parking spaces that are currently available versus the parking spaces that are currently unavailable or occupied. Distinguishing between available and non-available parking space can be obtained by a dedicated algorithm that utilizes the visual data provided by the camera(s) located in parking locations or adjacent to them, or by a variety of other techniques known in the art. For example, US 2013/0258107 discloses a method of determining parking lot occupancy from digital camera images.

Finding the GPS Location of Available Parking Spaces

As part of the process of finding available parking spaces, a coordinate algorithm, e.g., which can be based on known geospatial analysis, is applied to the data captured by the cameras. By doing so, the parking status (available or unavailable) and its real-world location (e.g., GPS coordinates) can be provided (e.g., in form a heatmap). These GPS coordinates can be added to a map, thereby enabling users to navigate to that specific parking space when using such a map as part of a navigation service. According to an embodiment of the invention, the detected and mapped parking spaces can be added to an existing navigation application/service as an additional data layer.

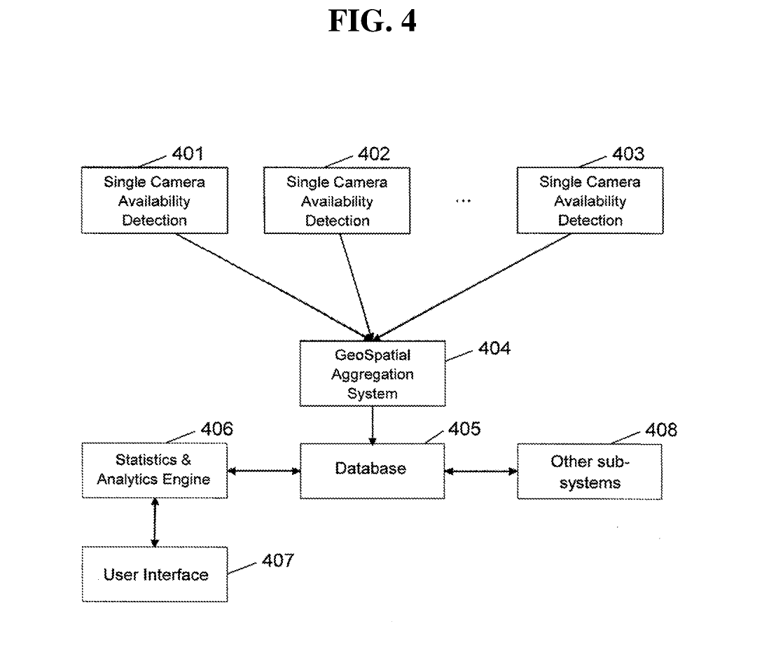

FIG. 4 schematically illustrates a heatmap generation of a parking lot, according to an embodiment of the invention. The heatmap generation includes the following components:
Cameras (as indicated by numeral 401-403) for providing images (or stream of images) in order to obtain the availability of each detected parking space (according to the method described hereinabove);
Geospatial spatial aggregation system 404 adapted to apply statistical analysis and other analytic techniques to data which has a geographical or spatial aspect, for obtaining Geographic information systems (GIS) data;
Database 405 for storing data provided by geospatial spatial aggregation system 404;
A statistical and analytics engine 406 for analyzing the GIS data;
A user interface 407 for displaying the analyzed data.
The data stored in database 405 can be further provided to other sub-systems or optional modules of server 2 (FIG. 2) such as the Violation Detection Module 102, a parking lot management system, municipal systems, etc.

Availability data (i.e., occupied or non-occupied parking space) is generated using the method of the present invention from each individual camera 401-403. The data is then passed into geospatial aggregation system 404 in order to compose full snapshot of the parking lot at that time. The data is saved in the database 405. Later the data is statistically analyzed by engine 406 and accordingly the heatmap is generated. A user friendly graphic representation of a specific generated heatmap is shown in FIG. 5.

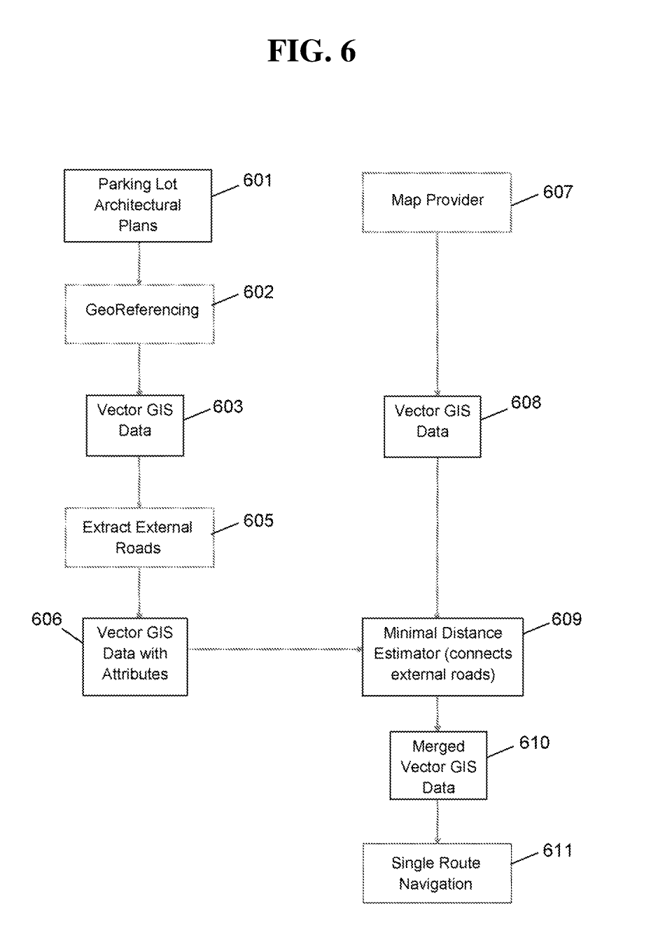

FIG. 6 schematically illustrates a process of generating a single vectorial route to a destination by combining a map generated by the system of the present invention and an external map source (e.g., Google® Maps), according to an embodiment of the invention. This method describe how to navigate using both a parking lot map (i.e., a parking lot architectural plan) generated by the system of the present invention (including the computer vision and machine learning described hereinabove) and the external map source provided by a third party map provider, while the transition is transparent to the user (e.g., as shown in FIG. 5, where the user sees the already combined map where the parking lot map is provided as a layer on top of the Google® Maps source, Waze® and the like).

The objective of this process is to create a single vectorial route (in world coordinates) from the user to the destination parking space. The process may involve the following procedures:
Providing parking lot architectural plans (block 601) and providing external map from third party map provider (block 607);
GeoReferencing the provided parking lot architectural plans (block 602) for obtaining vector GIS data (block 603). As parking lots usually have limited space, the GeoReferencing procedure involves Helmert transformation that is adapted to perform rotation and scaling in order to match the vectors, and in case there are not enough sampling points, a linear resampling can be used in order to artificially increase the amount of vectors.
Extracting vector GIS data from the external map (block 608);
Extracting external roads by applying vectorial analysis of the map data and identifying which internal roads within the parking lot need to be connected with external roads outside the parking lot (block 605)
Generating vector GIS data with attributes (block 606) to the GIS data provided at block 605. The attributes may include information such as one-way or two-way road, vehicle's height limitations (e.g., due to a bridge that crosses that road, etc.
Connecting external roads from each map source (block 609) by using a minimal distance estimator. In order to connect roads from each map source (i.e., from the parking lot architectural plans and from the third party map provider) the system searches for the closest edges inside a bounding box and bridge the gap. The system can dynamically calculate the bounding box and the relevant tolerance in order to get a single result which is the actual real world connection between the roads (i.e., minimal distance estimator);
Merging vector GIS Data of both map sources (block 610); and accordingly
Generating a single route navigation (block 611).

Navigating with Self-Driving Vehicle

According to an embodiment of the invention, the mapped parking locations and/or coordinates of individual parking spaces can be provided to a self-driving vehicle (i.e., an autonomous car) via the Self-driving car API 103 of server 2, thereby enabling a self-driving vehicle (e.g., by using a navigation module embedded with such a vehicle) to automatically navigate to the exact location of a detected available parking space and to automatically park there (i.e., enable to easily find and park at an available parking space detected by the system of the present invention). In addition, the system may provide the self-driving vehicle data obtained by the computer vision and machine learning regarding the available parking spaces, in order to increase the probability to navigate to a parking space that will remain free on arrival of the self-driving vehicle.

For example, the self-driving vehicle may perform all safety-critical functions for the entire drive, with the driver not expected to control the vehicle at any time. As such vehicle may control all functions from start to stop, including all navigation and parking functions, it could include unoccupied cars to automatically park the car for the driver. In such scene, the driver may exit the car at any desired location, prior to the parking, such as in front of an entrance to a shopping mall or elsewhere in the entire city, while the car will continue to automatically navigate from that location, to the actual parking space (i.e., to an available parking space, e.g., as provided by the system of the present invention). Upon parking, the system may report to the user the parking space location of the car, i.e., the location of the parking space in which his/her self-driving car parks.

According to an embodiment of the present invention, the system enables the self-driving vehicle to automatically navigate from the parking space to another location as instruct by the user or a service. For example, the user may use the mobile app to notify the self-driving vehicle about his/her exact location, thereby providing an automatic “pick-up” service. The user may provide the system (e.g., through a smartphone application) his/her current location for “pick up”. Alternatively, the location of the user can be the same place where the user left the car prior to the parking.

With respect to self-driving vehicle, the terms “navigation service” or “navigation application” or “navigation module” are used herein to indicate a system that aids in navigation. The systems may be entirely on board of a self-driving vehicle (e.g., embedded within a self-driving car), or they may be located elsewhere and communicate via radio or other signals with the self-driving vehicle, or they may use a combination of these methods. Such a system may be capable of: containing maps, which may be displayed in human readable format via text or in a graphical format, determining a vehicle location via sensors, maps, or information from external sources, providing suggested directions to a human in charge of a vehicle via text or speech, providing directions directly to a navigation module associated with the self-driving vehicle, providing information on nearby available parking spaces or mapped POI, providing information on traffic conditions and suggesting alternative directions to the available parking space.

Violation Detection Module

According to an embodiment of the present invention, system 10 may include the violation detection module 102 (FIG. 2) for detecting whenever a parking car violates parking terms. For example, system 10 can distinguish between an allowed parking region and a non-allowed region by parsing the identified roadside texture with respect to the color of the painted curbstones. Upon detecting that a car is parking in a non-allowed region and that the parking term has been violated (block 307 in FIG. 3), system 10 may generate an alert or notify the appropriate authority or entity about this parking violation (block 308 in FIG. 3). The violation detection module 102 may include the automatic number plate recognition (ANPR) component 111 (FIG. 2) that may use optical character recognition on images captured by the cameras to read the registration plates of the parking violated vehicle.

Referring to blocks 309-311 in FIG. 3, according to an embodiment of the violation detection module 102 can be used to detect whether it's a free or non-free parking space (block 109) and record the parking period of a car in a parking space (the car can be identified by the ANPR component 111) and may use such information to charge the owner of the parking car accordingly if it is a non-free parking space (block 310) or just record the parking duration if it is a free parking space (block 311). The charge can be done directly to system 10 (e.g., using the internal billing module 110 shown in FIG. 2), via a third party service, or by the owner of the relevant parking location. The system may also generate overtime notifications or other notifications regarding the allowed parking period or when a parking vehicle exceeds a specific parking period.

According to an embodiment of the invention, in order to ensure that the system provide correct information about the same vehicle that continuously remains parked in the same parking space, the system may characterized the vehicle from obtained by a camera, by using image momentum, color, three-dimensional histogram (Red Green Blue) applying histogram algorithm of the gradient HOG, different viewing angles, object detection, and the like.

According to some embodiments of the invention, a further image processing algorithm can be applied to the data captured by the cameras for optimizing the locating of available and unavailable parking spaces, in order to obtain more accurate detection results. For example, this can be done by utilizing unique parameters of parking locations and vehicles (as will be described in further details hereinafter). After recognizing those unique parameters, it is easier for the system to distinguish between available and unavailable parking spaces. This optimization may increase the statistical probability that a vehicle is actually currently parking in a specific parking space (i.e., meaning the parking space is occupied/unavailable). The process of optimizing the locating of parking spaces may detect and use the following unique parameters in addition to the computer vision and machine learning described hereinabove:
in parking spaces: road asphalt color, length and size of available parking spaces, e.g., as determined by marking lines, etc.;
vehicles related: license plates, windows, side mirrors, car paint color against the asphalt, shadows on the asphalt caused by the vehicles during daylight, or under different lighting condition such as indoors lights or at night, etc.;
in cities: ability to see a curbstone (meaning that there is no car there to block it), colors of the curbstones (which identify the legality of that specific parking space), traffic sign recognition, etc.

A mobile device 2 provided with a dedicated application (herein a “mobile app”) that is adapted to communicate with the main server 1 via network 3 (such as the Internet) can be used by a user to obtain navigation services in conjunction with the availability parking spaces information provided by system 10. The mobile device 2 can be a portable information communication technology device such as a smartphone or any other computer based device equipped with navigation and communication capabilities, which enables to access, store, transmit, and manipulate information.

Avoiding Traffic

According to an embodiment of the invention, e.g., as part of the mobile app, the image processing may detect road traffic and crowded areas by utilizing real-time visual data that is obtained from plurality of cameras that may be disposed in different location along the navigation route to a specific parking space destination (e.g., street cameras, parking lots cameras, etc.), and accordingly to redirect the navigation route in real-time as to avoid traffic jam or crowded areas. For example, the busiest, most crowded parts of a parking area, including the busiest entrances, and before the user enters that parking location, the system may help to navigate the user away from those crowded areas of the parking location in order to decrease the time it may take for a user to arrive at the destination parking space.

Matching Vehicles to Appropriate Parking Spaces

According to an embodiment of the invention, the system calculates the size of an available parking space and matches it to the size of a user's vehicle. For example, a user may provide the vehicle's size (e.g., width and length and/or other information) to the system via the mobile app by selecting the vehicle model from a given menu, by taking one or more photos of the vehicle (e.g., vehicle's side and front views) from which the system may extract the size of the vehicle (e.g., using known measurements techniques that are based on image capturing by a camera such as Partometer or other camera based meter measuring tool capable of providing object's length, width, size or other relevant information). This ensures that the user is being directed to a parking space that accommodates the size of his or her vehicle.

In addition, the system is also able to recognize when a vehicle that is already parked in a parking location is taking up more than one parking space, and so the system can add that knowledge to the search for an appropriate parking space for the user.

Assigning Real-World GPS Coordinates to the World's Parking Spaces

The process of converting parking spaces from image-processing coordinates into real-world GPS coordinates, enables to provide a new standard in which individual parking spaces, which were previously unmapped, will now be automatically mapped with GPS coordinates. This new reality, will allow any driver having a mobile device (e.g., a smartphone) equipped with a mobile app that support the parking space service as suggested by the method of the present invention, to navigate to any available parking space of his or her choice. Moreover, implementing a navigation and parking service based on the aforementioned embodiments of the present invention, may also save time to the user in searching for an available parking space, even after entrancing to known parking lots, as the driver gets the exact direction to the location of a specific available parking space, either in the parking lot or in any other region or crowded areas with limited available parking spaces.

According to an embodiment of the invention, the mobile app may operate as follows:
The user opens the mobile app installed on his or her mobile device (e.g., smart phone), and provides information about the desired destination—for example, the name of a shopping mall, the name of a parking lot, the name of a street in a city.
The information can be more specific by then providing which store within a shopping center they want to park near, or the gate at a stadium, or the terminal at an airport where they want to park, etc. At first, the mobile app may show the user all the available parking spaces around the current location of the user.
The provided information is transmitted as GPS coordinates to the system's servers 1. The system's server 1 uses those coordinates to locate the closest available parking space near the user's final desired coordinates.
After the system locates the target (i.e., the available parking space), the server returns to the real-world GPS coordinates of the target parking space to the mobile app, thereby allowing the mobile app to navigate the user to the available target parking space.
In case the destination parking space was captured by another car, prior to the arrival of the driver who is currently navigating there, the system may calculate and search for an alternative available parking space and provides the coordinates of the alternative parking space to the navigation service to recalculate the destination, either automatically or upon a user approval.

Building a Valuable Data Base

When users register to the service provided by system 10 (e.g., via the mobile app of device 2), they may provide data about themselves and their car. This data will enable the system to provide users with the most optimal parking space according to their needs. In order to provide easy access to the mobile app, users may also register to the service via their account at a third party social network such as Facebook, LinkedIn, Google+, etc. For example, the registration data may include make and model of the user's vehicle, user's age, user's gender, user's marital status (single, married, with children), etc. The database may further store data related to POI including their real-world coordinate, as to enable navigate a user as close as possible to a parking space near a desired POI (e.g., as shown with respect to FIG. 5). Knowing the user's parking space destination, the system may provide commercial content tailored for the user while considering the location of nearby POI or previous user's behavior and use of the service provided by the system of the invention.

According to an embodiment of the invention, when users provide their data, it will not only serve to optimize the system's ability to locate their ideal parking space, but also may serve as a big data source. Thus, as the number of the system users increases, this database may help to provide a valuable database of users' consumption data. Optionally, the system may track the route of the user after during the time the user's car is located in being parked in the parking space.

Additional Tools and Uses of the System

According to an embodiment of the invention, in addition to the mapping, locating and navigating systems, the system may also offer additional tools for business owners and application users, as follows:
For application users, the system may offer the following services within the application: i) users can make parking payments within the mobile app. Ii) users can use the mobile app to help them locate their vehicle when returning to their parking location. The system remembers where the user parked and directs them back to their vehicle.
For business owners, the system may offer the following additional services: i) the system may offer business owners reports on the busiest parts of their parking areas, including a statistical breakdown on the number of vehicles depending on the hour, the day, the month or the year. ii. the system may detect how long vehicles are parking in a parking location, and accordingly may alert business owners when a vehicle has been parked longer than the a requested/allowed time limit. iii. The system may report to shopping center owners on the most frequently requested shops at their shopping centers, etc.

Operating System for Underground/Indoor Parking Locations

In some underground/indoor parking locations, there might be a problem with GPS connectivity that makes it difficult for the system to deliver information to the user. Therefore, for such parking locations it is required to provide a solution that overcomes and resolves the connectivity issue, regardless of GPS reception.

According to an embodiment of the invention, due to these conditions in underground/indoor parking lots, system 10 may further include an independent navigation system that not require any GPS service (herein an underground sub-system) of detection and navigation for vacant parking space. The underground sub-system may involve the following steps:
At the entrance and/or in other strategic parts of underground parking lots, a camera is provided that operates with an image-processing algorithm such as LPR (License Plate Recognition). LPR detects license plates in order to calculate the location of a vehicle within the parking lot, since standard GPS may not performs this role. Each license plate detected by the LPR algorithm is saved in in a database associated with the system's server;
As the user drives through an underground parking lot, the image-processing algorithm (i.e., LPR) continues to track the users' vehicle based on the detection of his or her license plate. Based on the users' location and direction, a separate algorithm is constantly calculating the probability of where the car is going to be in the next following second.
At every entrance and exit to a row/floor in an underground parking lot, a camera is placed such that it will be able to capture the vehicles' license plates (e.g., the camera can be placed few centimeters above the ground at the height of an averages location of vehicles' license plates). Using the LPR, the license plate is recorded in the system. The system then performs a comparison between the license plate of the vehicle entering and exiting the row, with the license plate of the vehicle that was being navigated, in order to recognize that once this vehicle has successfully parked, the system no longer needs to navigate that specific vehicle.
The algorithm is constantly counting the number of vehicles moving in and out of these rows at any given time, and the number of vacant parking spaces. With this data, the system automatically creates a map of available parking spaces in each parking lot row.
As mentioned above, when a vehicle drives past the cameras, the license plate is recorded in the system. Because there are several cameras deployed throughout the parking lot, the system is able to know, based on a vehicle's passing by a camera, the location of the vehicle relative to a camera.
With this data on the number of parking spaces and the map of vacant parking spaces, the system is able to direct users to their nearest available parking space designated by this underground sub-system, which is independent from a GPS connection or any other external system.

As will be appreciated by the skilled person the embodiments described hereinabove results in a system capable of detecting available parking spaces and directing a driver to the exact location of an available parking space.

All the above will be better understood through the following illustrative and non-limitative examples.

For example, the process of navigating a user to an available parking space that best match the user's desired destination may involve the following steps:
A user of the system (e.g., a registered driver) accesses the mobile app on the mobile device 2 (e.g., iPhone, android OS based smartphone, etc.);
The user enters a destination address (e.g., by typing, selecting from a given menu, using voice commands, etc.);
The mobile app sends a message with the user input (i.e., the user's navigation request) to the main server 1;
Upon receiving the user input, the server 1 finds the currently available parking space that matches the user's navigation request, and accordingly sends the navigation coordinates of that available parking space to the mobile app;
The mobile app receives the destination coordinates and accordingly directs the user to that available parking space by taking into consideration data such as the parking lot traffic or other information that can be retrieved from the data captured by the cameras.

Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

Further, with respect to the example processes described hereinabove, not all the process states need to be reached, nor do the states have to be performed in the illustrated order. Further, certain process states that are illustrated as being serially performed can be performed in parallel.

The terms, “for example”, “e.g.”, “optionally”, as used herein, are intended to be used to introduce non-limiting examples. While certain references are made to certain example system components or services, other components and services can be used as well and/or the example components can be combined into fewer components and/or divided into further components.

All the above description and examples have been given for the purpose of illustration and are not intended to limit the invention in any way. Many different methods of analysis data captured by a camera, electronic and logical elements can be employed, all without exceeding the scope of the invention.

1. A method for automatically detecting and mapping parking spaces, comprising the steps of:
a) extracting parking space regions from images captured by one or more cameras by applying image processing algorithm for automatically defining areas in said images as parking spaces, wherein said image processing algorithm involves unsupervised camera calibration based on road surface marking and size estimation of a standard parking space for providing independent geometrical calibration of said one or more cameras without any human intervention; and
b) mapping the extracted parking spaces by assigning to each individual parking space real-world coordinates, by using a coordinate algorithm that projects and transforms image processing coordinates into real world coordinates.

2. A method according to claim 1, further comprising automatically distinguishing between currently available and unavailable parking spaces among the extracted parking spaces, thereby detecting available parking space in real-time.

3. A method according to claim 2, further comprising independently and autonomously learning life span availability of a parking space, thereby enabling to navigate a user in real-time to a parking space that has the highest probability to remain free on arrival, as well as enhancing the estimated arrival time for the actual parking space.

4. A method according to claim 3, further comprising enabling navigating the user in real-time to an available parking space that is close as possible to a desired POI, thereby also eliminating the need to search for an available parking space within a parking lot or other parking area with respect to a desired POI.

5. A method according to claim 1, further comprising applying an optimization process for distinguish in real-time between available and unavailable parking space by utilizing unique parameters of parking locations and vehicles.

6. A method according to claim 1, further comprising detecting crowded parts of a parking area, including the busiest entrances, thereby enabling to navigate the user away from those crowded areas to less crowded entrance in order to decrease the time it takes for a user to arrive at his or her parking space.

7. A method according to claim 1, further comprising providing an underground sub-system for detecting a vacant parking space in an underground parking lot and accordingly providing navigation data to said vacant parking space, by detecting and tracking the license plate of each vehicle that drives through said underground parking lot, using a plurality of cameras deployed in said underground parking lot.

8. A method according to claim 1, further comprising assigning real-world coordinates to non-parking Point-of-Interest (POI) for mapping said POI, thereby enabling a navigation service to navigate a user directly to an available parking space that is located as close as currently possible to a desired POI.

9. A method according to claim 8, wherein the POI is a specific point location that someone may find useful or interesting including place of business or service such as point-of-sale, stores, shops, service providers, restaurants, theaters, hotels, campsites, and the like.

10. A method according to claim 8, wherein the mapped POI are added to an existing navigation application/service as an additional data layer.

11. A method according to claim 1, further comprising defining the size of each parking space, thereby enabling to match the size of a specific vehicle with an available parking space having corresponding sizing.

12. A method according to claim 1, further comprising enabling a self-driving vehicle to automatically navigate to the location of a currently available parking space in order to park in said parking space, by providing data representing the real world coordinates of mapped parking space.

13. A method according to claim 12, further comprising enabling the self-driving vehicle to report the location in which said self-driving is actually parking.

14. A method according to claim 12, further comprising providing data relative to allowable parking terms in a parking area.

15. A method according to claim 14, further comprising detecting whenever a parking car violates the parking terms and accordingly generating a notification.

16. A method according to claim 12, further comprising enabling a self-driving vehicle to automatically exit from the parking space and to navigate to another location according to instruction provided by a user or a service.

17. A method according to claim 16, wherein the another location is the exact location of a user, thereby providing an automatic “pick-up” service.

18. A method according to claim 1, further comprising applying computer vision technique for enabling to learn the properties of each parking space, thereby enabling to navigate a user in real-time to a parking space that has the highest probability to remain free on arrival.

19. A system for automatically detecting and mapping parking spaces, comprising:
a) at least one processor; and
b) a memory comprising computer-readable instructions which when executed by the at least one processor causes the processor to execute a service for detecting and mapping parking spaces, wherein the service:
i. extracts parking space regions from images captured by one or more cameras by applying image processing algorithm(s) for automatically defining areas in said images as parking spaces;
ii. maps the extracted parking spaces by assigning to each individual parking space real-world coordinates, by using a coordinate algorithm that projects and transforms image processing coordinates into real world coordinates; and
iii. stores said mapped parking spaces in a database.

20. The system according to claim 19, further comprising a parking space occupancy model for automatically distinguishing between currently available and unavailable parking spaces among the extracted parking spaces, thereby detecting available parking space in real-time.

21. A non-transitory computer-readable medium comprising instructions which when executed by at least one processor causes the processor to perform the method of claim 1.
